(19) United States
(12) Patent Application Publication
(10) Pub. No.: US 2007/0186049 A1
(43) Pub. Date: Aug. 9, 2007

(54) Self prefetching L2 cache mechanism for instruction lines

(75) Inventor: David A. Luick, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: International Business Machines Corporation, Armonk, NY (US)

(21) Appl. No.: 11/347,412

(22) Filed: Feb. 3, 2006

(51) Int. Cl. G06F 12/00

(52) U.S. Cl. 711/137

(57) ABSTRACT

Embodiments of the present invention provide a method and apparatus for prefetching instruction lines. In one embodiment, the method includes fetching a first instruction line from a level 2 cache, identifying, in the first instruction line, a branch instruction targeting an instruction that is outside of the first instruction line, extracting an address from the identified branch instruction, and prefetching, from the level 2 cache, a second instruction line containing the targeted instruction using the extracted address.

### CROSS-REFERENCE TO RELATED APPLICATIONS

This application is related to commonly-owned U.S. patent application ______ entitled “SELF PREFETCHING L2 CACHE MECHANISM FOR DATA LINES”, filed on (Atty Docket ROC920050277US1), which is herein incorporated by reference in its entirety.

### BACKGROUND OF THE INVENTION

1. Field of the Invention

The present invention generally relates to the field of computer processors. More particularly, the present invention relates to caching mechanisms utilized by a computer processor.

2. Description of the Related Art

Modern computer systems typically contain several integrated circuits (ICs), including a processor which may be used to process information in the computer system. The data processed by a processor may include computer instructions which are executed by the processor as well as data which is manipulated by the processor using the computer instructions. The computer instructions and data are typically stored in a main memory in the computer system.

Processors typically process instructions by executing the instruction in a series of small steps. In some cases, to increase the number of instructions being processed by the processor (and therefore increase the speed of the processor), the processor may be pipelined. Pipelining refers to providing separate stages in a processor where each stage performs one or more of the small steps necessary to execute an instruction. In some cases, the pipeline (in addition to other circuitry) may be placed in a portion of the processor referred to as the processor core. Some processors may have multiple processor cores.

As an example of executing instructions in a pipeline, when a first instruction is received, a first pipeline stage may process a small part of the instruction. When the first pipeline stage has finished processing the small part of the instruction, a second pipeline stage may begin processing another small part of the first instruction while the first pipeline stage receives and begins processing a small part of a second instruction. Thus, the processor may process two or more instructions at the same time (in parallel).

To provide for faster access to data and instructions as well as better utilization of the processor, the processor may have several caches. A cache is a memory which is typically smaller than the main memory and is typically manufactured on the same die (i.e., chip) as the processor. Modern processors typically have several levels of caches. The fastest cache which is located closest to the core of the processor is referred to as the Level 1 cache (L1 cache). In addition to the L1 cache, the processor typically has a second, larger cache, referred to as the Level 2 Cache (L2 cache). In some cases, the processor may have other, additional cache levels (e.g., an L3 cache and an L4 cache).

To provide the processor with enough instructions to fill each stage of the processor's pipeline, the processor may retrieve instructions from the L2 cache in a group containing multiple instructions, referred to as an instruction line. The retrieved instruction line may be placed in the L1 instruction cache (I-cache) where the core of the processor may access instructions in the instruction line. Blocks of data to be processed by the processor may similarly be retrieved from the L2 cache and placed in the L1 cache data cache (D-cache).

The process of retrieving information from higher cache levels and placing the information in lower cache levels may be referred to as fetching, and typically requires a certain amount of time (latency). For instance, if the processor core requests information and the information is not in the L1 cache (referred to as a cache miss), the information may be fetched from the L2 cache. Each cache miss results in additional latency as the next cache/memory level is searched for the requested information. For example, if the requested information is not in the L2 cache, the processor may look for the information in an L3 cache or in main memory.

In some cases, a processor may process instructions and data faster than the instructions and data are retrieved from the caches and/or memory. For example, after an instruction line has been processed, it may take time to access the next instruction line to be processed (e.g., if there is a cache miss when the L1 cache is searched for the instruction line containing the next instruction). While the processor is retrieving the next instruction line from higher levels of cache or memory, pipeline stages may finish processing previous instructions and have no instructions left to process (referred to as a pipeline stall). When the pipeline stalls, the processor is underutilized and loses the benefit that a pipelined processor core provides.

Because instructions (and therefore instruction lines) are typically processed sequentially, some processors attempt to prevent pipeline stalls by fetching a block of sequentially-addressed instruction lines. By fetching a block of sequentially-addressed instruction lines, the next instruction line may be already available in the L1 cache when needed such that the processor core may readily access the instructions in the next instruction line when it finishes processing the instructions in the current instruction line.

In some cases, fetching a block of sequentially-addressed instruction lines may not prevent a pipeline stall. For instance, some instructions, referred to as exit branch instructions, may cause the processor to branch to an instruction (referred to as a target instruction) outside the block of sequentially-addressed instruction lines. Some exit branch instructions may branch to target instructions which are not in the current instruction line or in the next, already-fetched, sequentially-addressed instruction lines. Thus, the next instruction line containing the target instruction of the exit branch may not be available in the L1 cache when the processor determines that the branch is taken. As a result, the pipeline may stall and the processor may operate inefficiently.

With respect to fetching data, where an instruction accesses data, the processor may attempt to locate the data line containing the data in the L1 cache. If the data line cannot be located in the L1 cache, the processor may stall while the L2 cache and higher levels of memory are searched for the desired data line. Because the address of the desired data may not be known until the instruction is executed, the processor may not be able to search for the desired data line until the instruction is executed. When the processor does search for the data line, a cache miss may occur, resulting in a pipeline stall.

Some processors may attempt to prevent such cache misses by fetching a block of data lines which contain data addresses near the data address which is currently being accessed. Fetching nearby data lines relies on the assumption that when a data address in a data line is accessed, nearby data addresses will also typically be accessed as well (referred to as locality of reference). However, in some cases, the assumption may prove incorrect, such that data in data lines which are not located near the current data line are accessed by an instruction, thereby resulting in a cache miss and processor inefficiency.

Accordingly, there is a need for improved methods of retrieving instructions and data in a processor which utilizes cached memory.

### SUMMARY OF THE INVENTION

Embodiments of the present invention provide a method and apparatus for prefetching instruction lines. In one embodiment, the method includes (a) fetching a first instruction line from a level 2 cache, (b) identifying, in the first instruction line, a branch instruction targeting an instruction that is outside of the first instruction line, (c) extracting an address from the identified branch instruction, and (d) prefetching, from the level 2 cache, a second instruction line containing the targeted instruction using the extracted address.

In one embodiment, a processor is provided. The processor includes a level 2 cache, a level 1 cache, a processor core, and circuitry. The level 1 cache is configured to receive instruction lines from the level 2 cache, wherein each instruction line comprises one or more instructions. The processor core is configured to execute instructions retrieved from the level 1 cache. The circuitry is configured to (a) fetch a first instruction line from a level 2 cache, (b) identify, in the first instruction line, a branch instruction targeting an instruction that is outside of the first instruction line, (c) extract an address from the identified branch instruction, and (d) prefetch, from the level 2 cache, a second instruction line containing the targeted instruction using the extracted address.

In one embodiment, a method of storing exit branch addresses in an instruction line is provided. The instruction line comprises one or more instructions. The method includes executing one of the one or more instructions in the instruction line, determining if the one of one or more of the instructions branches to an instruction in another instruction line, and, if so, appending an exit address to the instruction line corresponding to the other instruction line.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram depicting a system according to one embodiment of the invention.

FIG. 2 is a block diagram depicting a computer processor according to one embodiment of the invention.

FIG. 3 is a diagram depicting multiple exemplary instruction lines (I-lines) according to one embodiment of the invention.

FIG. 4 is a flow diagram depicting a process for preventing L1 I-cache misses according to one embodiment of the invention.

FIG. 5 is a block diagram depicting an I-line containing a branch exit address according to one embodiment of the invention.

FIG. 6 is a block diagram depicting circuitry for prefetching instruction and data lines according to one embodiment of the invention.

FIG. 7 is a flow diagram depicting a process for storing a branch exit address corresponding to an exit branch instruction according to one embodiment of the invention.

### DETAILED DESCRIPTION OF THE PREFERRED EMBODIMENTS

Embodiments of the present invention provide a method and apparatus for prefetching instruction lines. For some embodiments, an instruction line being fetched may be examined for “exit branch instructions” that branch to (target) instructions that lie outside the instruction line. The target address of these exit branch instructions may be extracted and used to prefetch, from L2 cache, the instruction line containing the targeted instruction. As a result, if/when the exit branch is taken, the targeted instruction line may already be in the L1 instruction cache (“I-cache”), thereby avoiding a costly miss in the I-cache and improving overall performance.

For some embodiments, prefetch data may be stored in a traditional cache memory in the corresponding block of information (e.g. instruction line or data line) to which the prefetch data pertains. As the corresponding block of information is fetched from the cache memory, the block of information may be examined and used to prefetch other, related blocks of information. Prefetches may then be performed using prefetch data stored in each other prefetched block of information. By using information within a fetched block of information to prefetch other blocks of information related to the fetched block of information, cache misses associated with the fetched block of information may be prevented.

According to one embodiment of the invention, storing the prefetch and prediction data in a traditional cache as part of a block of information may obviate the need for special caches or memories which exclusively store prefetch and prediction data (e.g., prefetch and prediction data for data lines and/or instruction lines). However, while described below with respect to storing such information in instruction lines, such information may be stored in any location, including special caches or memories devoted to storing such history information. In some cases, a combination of different caches (and cache lines), buffers, special-purpose caches, and other locations may be used to store history information described herein.

The following is a detailed description of embodiments of the invention depicted in the accompanying drawings. The embodiments are examples and are in such detail as to clearly communicate the invention. However, the amount of detail offered is not intended to limit the anticipated variations of embodiments; but on the contrary, the intention is to cover all modifications, equivalents, and alternatives falling within the spirit and scope of the present invention as defined by the appended claims.

Embodiments of the invention may be utilized with and are described below with respect to a system, e.g., a computer system. As used herein, a system may include any system utilizing a processor and a cache memory, including a personal computer, internet appliance, digital media appliance, portable digital assistant (PDA), portable music/video player and video game console. While cache memories may be located on the same die as the processor which utilizes the cache memory, in some cases, the processor and cache memories may be located on different dies (e.g., separate chips within separate modules or separate chips within a single module).

While described below with respect to a processor having multiple processor cores and multiple L1 caches, wherein each processor core uses a pipeline to execute instructions, embodiments of the invention may be utilized with any processor which utilizes a cache, including processors which have a single processing core and/or processors which do not utilize a pipeline in executing instructions. In general, embodiments of the invention may be utilized with any processor and are not limited to any specific configuration.

While described below with respect to a processor having an L1-cache divided into an L1 instruction cache (L1 I-cache) and an L1 data cache (L1 D-cache), embodiments of the invention may be utilized in configurations wherein a unified L1 cache is utilized. Furthermore, while described below with respect to prefetching I-lines and D-lines from an L2 cache and placing the prefetched lines into an L1 cache, embodiments of the invention may be utilized to prefetch I-lines and D-lines from any cache or memory level into any other cache or memory level.

### Overview of an Exemplary System

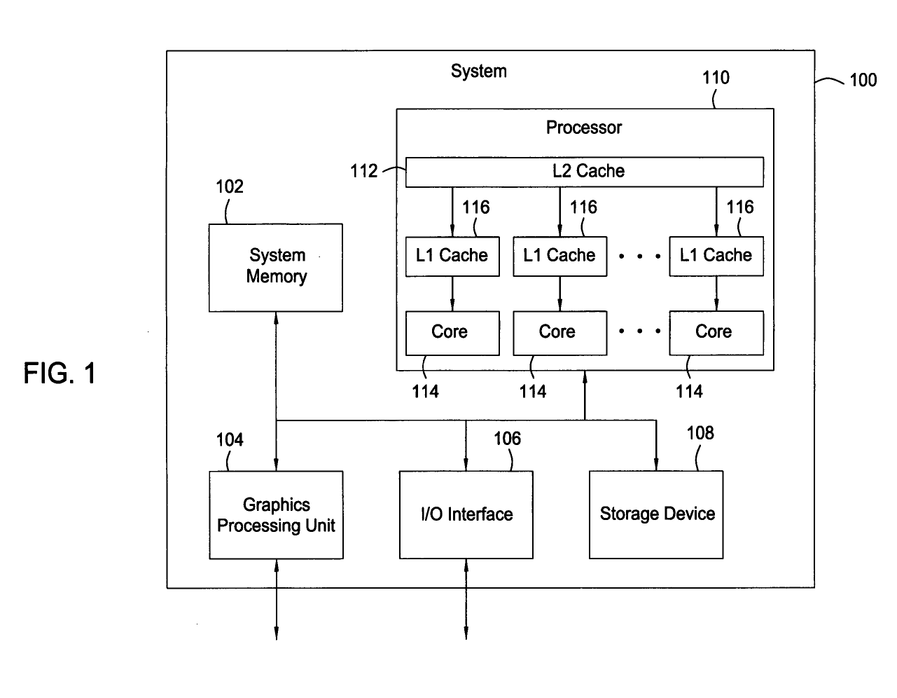

FIG. 1 is a block diagram depicting a system 100 according to one embodiment of the invention. The system 100 may contain a system memory 102 for storing instructions and data, a graphics processing unit 104 for graphics processing, an I/O interface for communicating with external devices, a storage device 108 for long term storage of instructions and data, and a processor 110 for processing instructions and data.

According to one embodiment of the invention, the processor 110 may have an L2 cache 112 as well as multiple L1 caches 116, with each L1 cache 116 being utilized by one of multiple processor cores 114. According to one embodiment, each processor core 114 may be pipelined, wherein each instruction is performed in a series of small steps with each step being performed by a different pipeline stage.

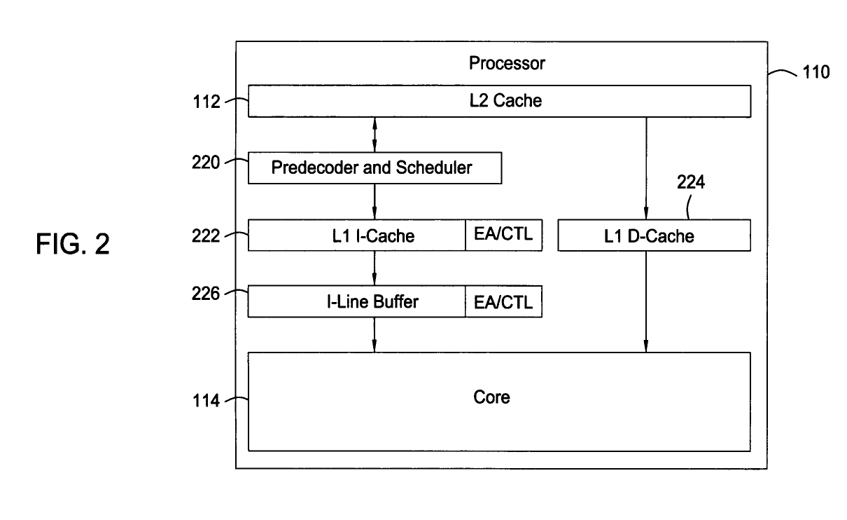

FIG. 2 is a block diagram depicting a processor 110 according to one embodiment of the invention. For simplicity, FIG. 2 depicts and is described with respect to a single core 114 of the processor 110. In one embodiment, each core 114 may be identical (e.g., contain identical pipelines with identical pipeline stages). In another embodiment, each core 114 may be different (e.g., contain different pipelines with different stages).

In one embodiment of the invention, the L2 cache may contain a portion of the instructions and data being used by the processor 110. In some cases, the processor 110 may request instructions and data which are not contained in the L2 cache 112. Where requested instructions and data are not contained in the L2 cache 112, the requested instructions and data may be retrieved (either from a higher level cache or system memory 102) and placed in the L2 cache. When the processor core 114 requests instructions from the L2 cache 112, the instructions may be first processed by a predecoder and scheduler 220 (described below in greater detail).

In one embodiment of the invention, the L1 cache 116 depicted in FIG. 1 may be divided into two parts, an L1 instruction cache 222 (L1 I-cache 222) for storing instruction lines as well as an L1 data cache 224 (L1 D-cache 224) for storing data lines (D-lines). After I-lines retrieved from the L2 cache 112 are processed by a predecoder and scheduler 220, the I-lines may be placed in the I-cache 222.

In one embodiment of the invention, instructions may be fetched from the L2 cache 112 and the I-cache 222 in groups, referred to as instruction lines (I-lines) and placed in an I-line buffer 226 where the processor core 114 may access the instructions in the I-line. In one embodiment, a portion of the I-cache 222 and the I-line buffer 226 may be used to store effective addresses and controls bits (EA/CTL) which may be used by the core 114 and/or the predecoder and scheduler 220 to process each I-line, for example, to implement the instruction prefetching mechanism described below.

### Prefetching Instruction Lines from the L2 Cache

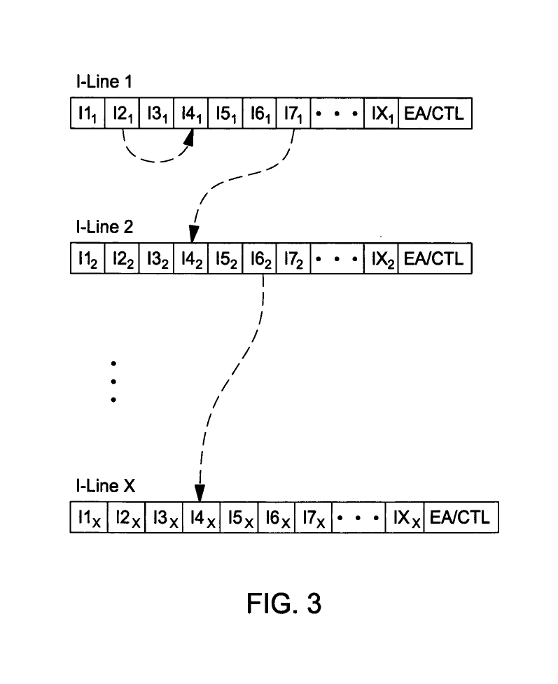

FIG. 3 is a diagram depicting multiple exemplary I-lines according to one embodiment of the invention. In one embodiment, each I-line may contain a plurality of instructions (e.g., I1, I2, I3, etc . . . ) as well as control information such as effective addresses and control bits. In some degree, the instructions in each I-line may be executed in order, such that instruction I1 is executed first, I2 is executed second, and so on. Because the instructions are executed in order, the I-lines are also typically executed in order. Thus, in some cases, each time an I-line is moved from the L2 cache 112 to the I-cache 222, the pre-decoder and scheduler 220 may examine the I-line (e.g., I-Line 1) and prefetch the next sequential I-line (e.g., I-line 2) so that the next I-line is placed in the I-cache 222 and accessible by the processor core 114.

In some cases, an I-line being executed by the processor core 114 may include branch instructions (e.g., conditional branch instructions). A branch instruction is an instruction which branches to another instruction (referred to herein as the target instruction). In some cases, the target instruction may be within the same I-line as the branch instruction. For example, instruction I2₁ depicted in FIG. 3 may specify that target instruction I4₁ should be executed if a certain condition is met (e.g., if a value stored in memory is zero). Because the I-line containing the target instruction (I-line 1) may already be in the I-cache 222, if the branch is taken to instruction I4₁ an I-cache miss may not occur, allowing the processor core 114 to continue processing instructions efficiently.

In some cases, the branch instruction may branch to an instruction outside the current I-line containing the branch instruction Branch instructions which branch to I-lines other than the current I-line are referred to herein as exit branch instructions or exit branches. Exit branch instructions may be unconditional branches (e.g., branch always) or conditional branch instructions (e.g., branch if equal to zero). For example, instruction I5₁ in I-line 1 may be a conditional branch instruction which branches to instruction I4₂ in I-line 2 if the corresponding condition is satisfied. In some cases, if the conditional branch is taken, assuming that I-line 2 is successfully fetched and is already located in the I-cache 222, the processor core 114 may successfully request instruction I4₂ from the I-cache 222 without an I-cache miss.

However, in some cases, a conditional branch instruction (e.g., instruction I6₁) may branch to a an instruction in an I-line (e.g., instruction I4ₓ in I-line X) which is not located in the I-cache 222, resulting in a cache miss and inefficient operation of the processor 110.

According to one embodiment of the invention, the number of I-cache misses may be reduced by prefetching a target I-line according to a branch exit address extracted from an I-line currently being fetched.

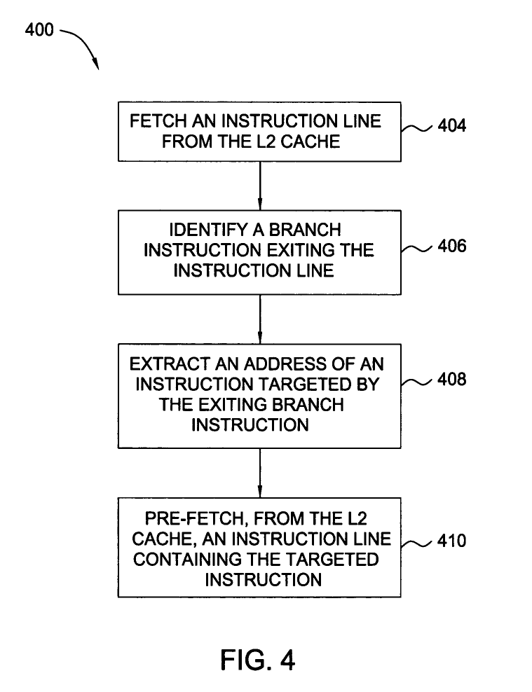

FIG. 4 is a flow diagram depicting a process 400 for preventing I-cache misses according to one embodiment of the invention. The process 400 may begin at step 404 where an I-line is fetched from the L2 cache 112. At step 406, a branch instruction exiting from the I-line may be identified, and at step 408 an address of an instruction targeted by the exiting branch instruction (referred to as a branch exit address) may be extracted. Then, at step 410, an instruction line containing the targeted instruction may be prefetched from the L2 cache 112 using the branch exit address. By prefetching the instruction line containing the targeted instruction and placing the prefetched instruction in the I-cache 222, a cache miss may thereby be prevented if/when the exit branch is taken.

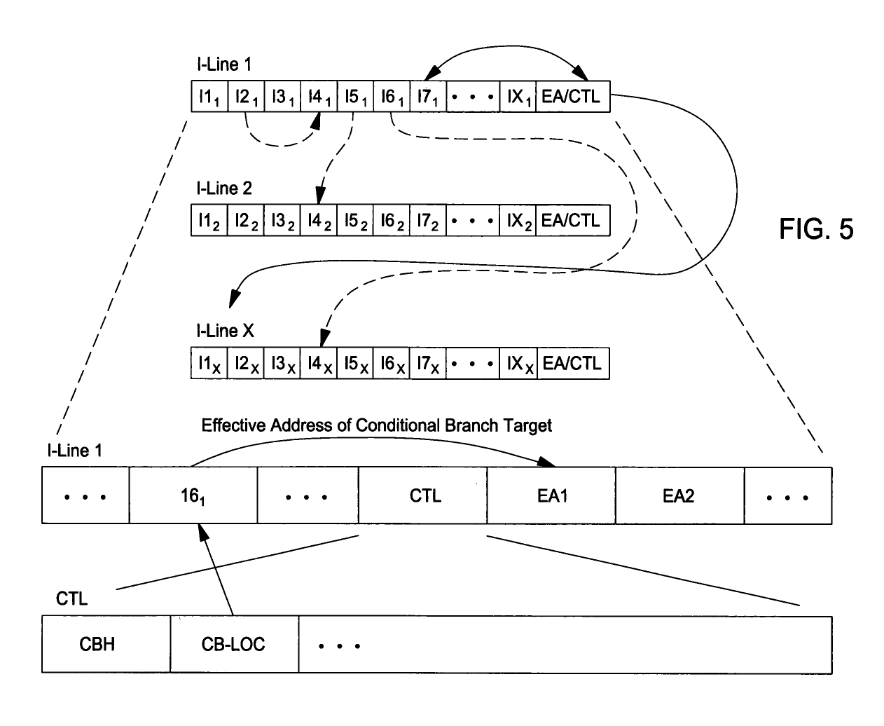

In one embodiment, the branch exit address may be stored directly in (appended to) an I-line. FIG. 5 is a block diagram depicting an I-line (I-line 1) containing an I-line branch exit address (EA1) according to one embodiment of the invention. The stored branch exit address EA1 may be an effective address or a portion of an effective address. As depicted, the branch exit address EA1 may identify an I-line containing an instruction I4ₓ targeted by branch instruction I6₁.

According to one embodiment, the I-line may also store other effective addresses (e.g., EA2) and control bits (e.g., CTL). As described below, the other effective addresses may be used to prefetch data lines corresponding to data access instructions in the I-line or additional branch instruction addresses. The control bits CTL may include one or more bits which indicate the history of a branch instruction (CBH) as well as the location of the branch instruction within the I-line (CB-LOC). Use of the information stored in the I-line is also described below.

### Exemplary Prefetch Circuitry

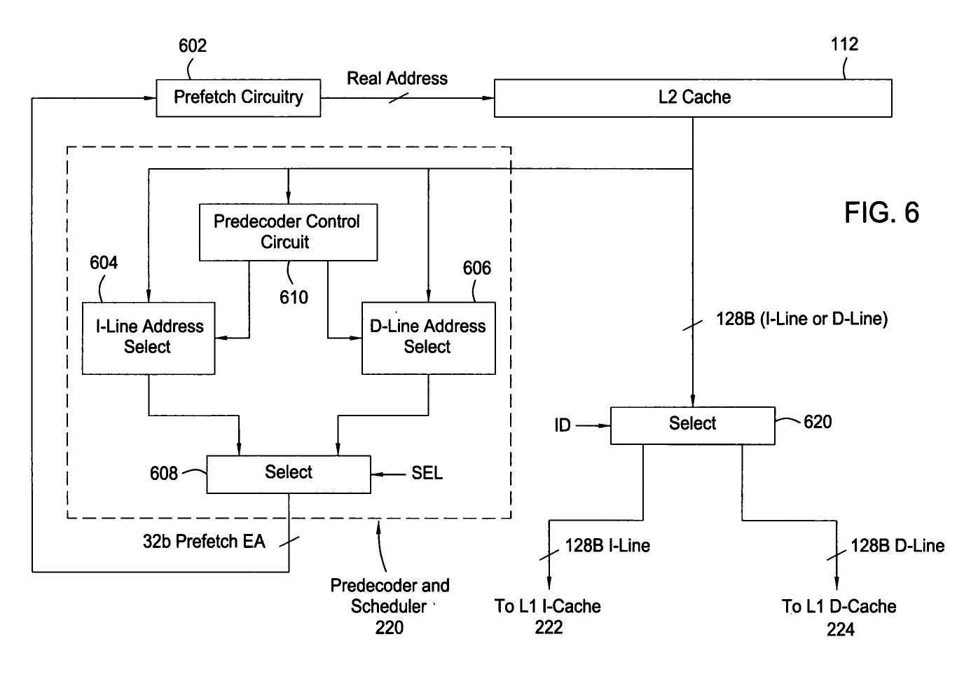

FIG. 6 is a block diagram depicting circuitry for prefetching instruction and data lines according to one embodiment of the invention. In one embodiment of the invention, the circuitry may prefetch only D-lines or only I-lines. In another embodiment of the invention, the circuitry may prefetch both I-lines and D-lines.

Each time an I-line or D-line is fetched from the L2 Cache 112 to be placed in the I-cache 222 or D-cache 224, respectively, select circuitry 620 controlled by an instruction/data (I/D) may route the fetched I-Line or D-line to the appropriate cache.

The predecoder and scheduler 220 may examine information being output by the L2 cache 112. In one embodiment, where multiple processor cores 114 are utilized, a single predecoder and scheduler 220 may be shared between multiple processor cores. In another embodiment, a predecoder and scheduler 220 may by provided separately for each processor core 114.

In one embodiment, the predecoder and scheduler 220 may have a predecoder control circuit 610 which determines if information being output by the L2 cache 112 is an I-line or D-line. For instance, the L2 cache 112 may set a specified bit in each block of information contained in the L2 cache 112 and the predecoder control circuit 610 may examine the specified bit to determine if a block of information output by the L2 cache 112 is an I-line or D-line.

If the predecoder control circuit 610 determines that the information output by the L2 cache 112 is an I-line, the predecoder control circuit 610 may use an I-line address select circuit 604 and a D-line address select circuit 606 to select any appropriate effective addresses (e.g., EA1 or EA2) contained in the I-line. The effective addresses may then be selected by select circuit 608 using the select (SEL) signal. The selected effective address may then be output to prefetch circuitry 602, for example, as a 32 bit prefetch address for use in prefetching the corresponding I-line or D-line from the L2 cache 112.

In some cases, a fetched I-line may contain a single effective address corresponding to a second I-line to be prefetched from main memory (e.g., containing an instruction targeted by an exit branch instruction). In other cases, the I-line may contain an effective address of a target I-line to be prefetched from main memory as well as an effective address of a target D-line to be prefetched from main memory. In other embodiments, each I-line may contain effective addresses for both multiple I-lines and/or multiple D-lines to be prefetched from main memory. According to one embodiment, where the I-line contains multiple effective addresses to be prefetched, the addresses may be temporarily stored (e.g., in the predecoder control circuit 610 or the I-Line address select circuit 604, or some other buffer) while each effective address is sent to the prefetch circuitry 602. In another embodiment, the prefetch address may be sent in parallel to the prefetch circuitry 602 and/or the L2 cache 112.

The prefetch circuitry 602 may determine if the requested effective address is in the L2 cache 112. For example, the prefetch circuitry 602 may contain a content addressable memory (CAM), such as a translation look-aside buffer (TLB) which may determine if a requested effective address is in the L2 cache 112. If the requested effective address is in the L2 cache 112, the prefetch circuitry 602 may issue a request to the L2 cache to fetch a real address corresponding to the requested effect address. The block of information corresponding to the real address may then be output to the select circuit 620 and directed to the appropriate L1 cache (e.g., the I-cache 222 or the D-cache 224). If the prefetch circuitry 602 determines that the requested effective address is not in the L2 cache 112, then the prefetch circuitry may send a signal to higher levels of cache and/or memory. For example, the prefetch circuitry 602 may send a prefetch request for the address to an L3 cache which may then be searched for the requested address.

In some cases, before the predecoder and scheduler 220 attempts to prefetch an I-line or D-line from the L2 cache 112, the predecoder and scheduler 220 (or, optionally, the prefetch circuitry 602) may determine if the requested I-line or D-line being prefetched is already contained in either the I-cache 222 or the D-cache 224. If the requested I-line or D-line is already located in the I-cache 222 or the D-cache 224, an L2 cache prefetch may be unnecessary and may therefore not be performed. In some cases, where the prefetch is rendered unnecessary, storing the current effective address in the I-line may also be unnecessary, allowing other effective addresses to be stored in the I-line (described below).

In one embodiment, as each prefetched line of information is fetched from the L2 cache 112, the prefetched information may also be examined by the predecoder and scheduler circuit 220 to determine if the prefetched information line is an I-line. If the prefetched information is an I-line, the I-line may be examined by the predecoder control circuit 610 to determine if the prefetched I-line contains any effective addresses corresponding, for instance, to another I-line containing an instruction targeted by a branch instruction in the prefetched I-line. If the prefetched I-line does contain an effective address pointing to another I-line, the other I-line may also be prefetched. The same process may be repeated on the second prefetched I-line, such that a chain of multiple I-lines may be prefetched based on branch exit addresses contained in each I-line.

In one embodiment of the invention, the predecoder and scheduler 220 may continue prefetching I-lines (and D-lines) until a threshold number of I-lines and/or D-lines has been fetched. The threshold may be selected in any appropriate manner. For example, the threshold may be selected based upon the number of I-lines and/or D-lines which may be placed in the I-cache and D-cache respectively. A large threshold number of prefetches may be selected where the I-cache and/or the D-cache have a larger capacity whereas a small threshold number of prefetches may be selected where the I-cache and/or D-cache have a smaller capacity.

As another example, the threshold number of prefetches may be selected based on the predictability of conditional branch instructions within the I-lines being fetched. In some cases, the outcome of the conditional branch instructions may be predictable (e.g., whether the branch is taken or not), and thus, the proper I-line to prefetch may be predictable. However, as the number of branch predictions between I-lines increases, the overall accuracy of the predictions may become small such that there may be a small chance a given I-line will be accessed. The level of unpredictability may increase as the number of prefetches which utilize unpredictable branch instructions increases.

Accordingly, in one embodiment, a threshold number of prefetches may be chosen such that the predicted likelihood of accessing a prefetched I-line does not fall below a given percentage. In some cases, the chosen threshold may be a fixed number selected according to a test run of sample instructions. In some cases, the test run and selection of the threshold may be performed at design time and the threshold may be pre-programmed into the processor 110. Optionally, the test run may occur during an initial “training” phase of program execution (described below in greater detail). In another embodiment, the processor 110 may track the number of prefetched I-lines containing unpredictable branch instructions and stop prefetching I-lines only after a given number of I-lines containing unpredictable branch instructions have been prefetched, such that the threshold number of prefetched I-lines varies dynamically based on the contents of the I-lines. Also, in some cases, where an unpredictable branch is reached (e.g., a branch where a predictability value for the branch is below a threshold for predictability), I-lines may be fetched for both paths of the branch instruction (e.g., for both the predicted branch path and the unpredicted branch path).

### Storing a Branch Exit Address for an Instruction Line

According to one embodiment of the invention, branch instructions within an I-line and branch exit addresses corresponding to the target of those branch instructions may be determined by executing instructions in the I-line. Executing instructions in the I-line may also be used to record the branch history of a branch instruction and thereby determine the probability that the branch will be followed to a target instruction in another I-line and thereby cause an I-cache miss.

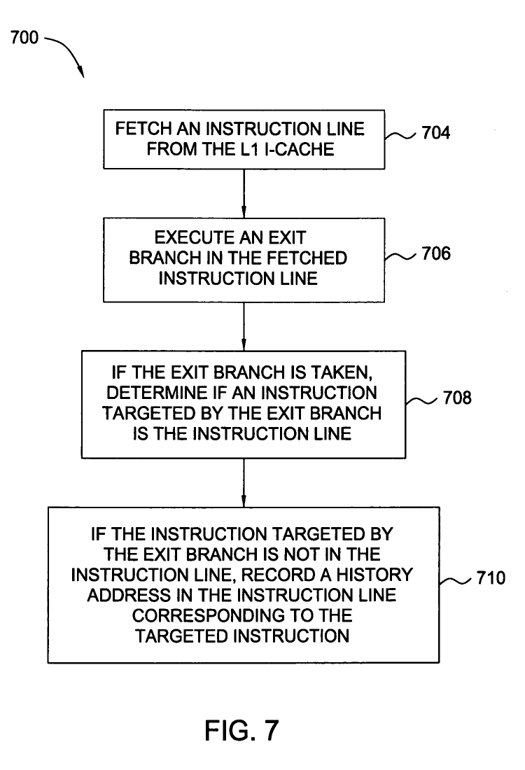

FIG. 7 is a flow diagram depicting a process 700 for storing a branch exit address corresponding to an exit branch instruction according to one embodiment of the invention. The process 700 may begin at step 704 where an instruction line is fetched, for example, from the I-cache 222. At step 706 an exit branch in the fetched instruction line may be executed. At step 708, if the exit branch is taken, a determination may be made of whether the instruction targeted by the exit branch is located in the fetched instruction line. At step 710, if the instruction targeted by the exit branch is not in the instruction line, the effective address of the targeted instruction is stored as the exit address. By recording the branch exit address corresponding to the targeted instruction, the next time the instruction line is fetched from the L2 cache 112, the I-line containing the targeted instruction may be prefetched from the L2 cache 112.

In one embodiment of the invention, the branch exit address may not be calculated until a branch instruction which branches to the branch exit address is executed. For instance, the branch instruction may specify an offset value from the address of the current instruction to which the branch should be made. When the branch instruction is executed and the branch is taken, the effective address of the branch target may be calculated and stored as the branch exit address. In some cases, the entire effective address may be stored. However, in other cases, only a portion of the effective address may be stored. For instance, a cached I-line containing the target instruction of the branch may be located using only the higher-order 32 bits of an effective address, then only those 32 bits may be saved as the branch exit address for purposes of prefetching the I-line.

### Tracking and Recording Branch History

In one embodiment of the invention, various amounts of branch history information may be stored. In some cases, the branch history may indicate which branch or branches in an I-line will be taken or have been taken. Which branch exit address or addresses are stored in an I-line may be determined based upon the stored branch history information generated during real-time execution or during a pre-execution “training” period.

According to one embodiment, as described above, only the branch exit address corresponding to the most recently taken exit branch in an I-line may be stored. Storing the branch exit address corresponding to the most recently taken branch in an I-line effectively predicts that the same exit branch will be taken when the I-line is subsequently fetched. Thus, the I-line containing the target instruction for the previously taken exit branch instruction may be prefetched.

In some cases, one or more bits may be used to record the history of exit branches which exit from the I-line and predict which exit branch will be taken when instructions in the fetched I-line are executed. For example, as depicted in FIG. 5, the control bits CTL stored in the instruction line (I-line 1) may contain information which indicates which exit branch in the I-line was previously taken (CB-LOC) as well as a history of when the branch was taken (CBH) (e.g., how many times that branch was taken in some number of previous executions).

As an example of how the branch location CB-LOC and branch history CBH may be used, consider an I-line in the L2 cache 112 which has not been fetched to the L1 cache 222. When the I-line is fetched to the L1 cache 222, the predecoder and scheduler 220 may determine that that I-line has no branch exit address and may accordingly not prefetch another I-line. Optionally, the predecoder and scheduler 220 may prefetch an I-line located at a next sequential address from the current I-line.

As instructions in the fetched I-line are executed, the processor core 114 may determine whether a branch within the I-line branches to a target instruction in another I-line. If such an exit branch is detected, the location of the branch within the I-line may be stored in CB-LOC in addition to storing the branch exit address in EA1. If each I-line contains 32 instructions, CB-LOC may be a five-bit binary number such that the numbers 0-31 (corresponding to each possible instruction location) may be stored in CB-LOC to indicate the exit branch instruction.

In one embodiment, a value may also be written to CBH which indicates that the exit branch instruction located at CB-LOC was taken. For example, if CBH is a single bit, during the first execution of the instructions in the I-line, when the exit branch instruction is executed, a 0 may be written to CBH. The 0 stored in CBH may indicate a weak prediction that the exit branch instruction located at CB-LOC will be taken during a subsequent execution of instructions contained in the I-line.

If, during a subsequent execution of instructions in the I-line, the exit branch located at CB-LOC is taken again, CBH may be set to 1. The 1 stored in CBH may indicate a strong prediction that the exit branch instruction located at CB-LOC will be taken again.

If, however, the same I-line (CBH=1) is fetched again and a different exit branch instruction is taken, the values of CB-LOC and EA1 may remain the same, but CBH may be cleared to a 0, indicating a weak prediction that the previously taken branch will be taken during a subsequent execution of the instructions contained in the I-line.

Where CBH is 0 (indicating a weak branch prediction) and an exit branch other than the exit branch indicated by CB-LOC is taken, the branch exit address EA1 may be overwritten with the target address of the taken exit branch and CB-LOC may be changed to a value corresponding to the taken exit branch in the I-line.

Thus, where branch history bits are utilized, the I-line may contain a stored branch exit address which corresponds to a predicted exit branch. Such regularly taken exit branches may be preferred over exit branches which are infrequently taken. If, however, the exit branch is weakly predicted and another exit branch is taken, the branch exit address may be changed to the address corresponding to the taken exit branch, such that weakly predicted exit branches are not preferred when other exit branches are regularly being taken.

In one embodiment, CBH may contain multiple history bits so that a longer history of the branch instruction indicated by CB-LOC may be stored. For instance, if CBH is two binary bits, 00 may correspond to a very weak prediction (in which case taking other branches will overwrite the branch exit address and CB-LOC) whereas 01, 10, and 11 may correspond to weak, strong, and very strong predictions, respectively (in which case taking other branches may not overwrite the branch exit address or CB-LOC). As an example, to replace a branch exit address corresponding to a strongly predicted exit branch, it may require that three other exit branches be taken on three consecutive executions of instructions in the I-line.

In one embodiment of the invention, multiple branch histories (e.g., CBH1, CBH2, etc.), multiple branch locations (e.g., CB-LOC1, CB-LOC2, etc.), and/or multiple effective addresses may be utilized. For example, in one embodiment, multiple branch histories may be tracked using CBH1, CBH2, etc., but only one branch exit address, corresponding to the most predictable branch out of CBH1, CBH2, etc., may be stored in EA1. Optionally, multiple branch histories and multiple branch exit addresses may be stored in a single I-line. In one embodiment, the branch exit addresses may be used to prefetch I-lines only where the branch history indicates that a given branch designated by CB-LOC is predictable. Optionally, only I-lines corresponding to the most predictable branch exit address out of several stored addresses may be prefetched by the predecoder and scheduler 220.

In one embodiment of the invention, whether an exit branch instruction causes an I-cache miss may be used to determine whether or not to store a branch exit address. For example, if a given exit branch rarely causes an I-cache miss, a branch exit address corresponding to the exit branch may not be stored, even though the exit branch may be taken more frequently than other exit branches in the I-line. If another exit branch in the I-line is taken less frequently but generally causes more I-cache misses, then a branch exit address corresponding to the other exit branch may be stored in the I-line. History bits, such as an I-cache “miss” flag, may be used as described above to determine which exit branch is most likely to cause an I-cache miss.

In some cases, a bit stored in the I-line may be used to indicate whether an instruction line is placed in the I-cache 222 because of an I-cache miss or because of a prefetch. The bit may be used by the processor 110 to determine the effectiveness of a prefetch in preventing a cache miss. In some cases, the predecoder and scheduler 220 (or optionally, the prefetch circuitry 602) may also determine that prefetches are unnecessary and change bits in the I-line accordingly. Where a prefetch is unnecessary, e.g., because the information being prefetched in already in the I-cache 222 or D-cache 224, other branch exit addresses corresponding to instructions which cause more I-cache and D-cache misses may be stored in the I-line.

In one embodiment, whether an exit branch causes an I-cache miss may be the only factor used to determine whether or not to store a branch exit address for an exit branch. In another embodiment, both the predictability of an exit branch and the predictability of whether the exit branch will cause an I-cache miss may be used together to determine whether or not to store a branch exit address. For example, values corresponding to the branch history and I-cache miss history may be added, multiplied, or used in some other formula (e.g., as weights) to determine whether or not to store a branch exit address and/or prefetch an I-line corresponding to the branch exit address.

In one embodiment of the invention, the branch exit address, exit branch history, and exit branch location may be continuously tracked and updated at runtime such that the branch exit address and other values stored in the I-line may change over time as a given set of instructions is executed. Thus, the branch exit address and the prefetched I-lines may be dynamically modified, for example, as a program is executed.

In another embodiment of the invention, the branch exit address may be selected and stored during an initial execution phase of a set of instructions (e.g., during an initial period in which a program is executed). The initial execution phase may also be referred to as an initialization phase or a training phase. During the initialization phase, branch histories and branch exit addresses may be tracked and one or more branch exit addresses may be stored in the I-line (e.g., according to the criteria described above). When the initial execution phase is completed, the stored branch exit addresses may continue to be used to prefetch I-lines from the L2 cache 112, however, the branch exit address(es) in the fetched I-line may no longer be tracked and updated.

In one embodiment, one or more bits in the I-line containing the branch exit address(es) may be used to indicate whether the branch exit address is being updated during the initial execution phase. For example, a bit may be cleared during the training phase. While the bit is cleared, the branch history may be tracked and the branch exit address(es) may be updated as instructions in the I-line are executed. When the training phase is completed, the bit may be set. When the bit is set, the branch exit address(es) may no longer be updated and the initial execution phase may be complete.

In one embodiment, the initial execution phase may continue for a specified period of time (e.g., until a number of clock cycles has elapsed). In one embodiment, the most recently stored branch exit address may remain stored in the I-line when the specified period of time elapses and the initial execution phase is exited. In another embodiment, a branch exit address corresponding to the most frequently taken exit branch or corresponding to the exit branch causing the most frequent number of I-cache misses may be stored in the I-line and used for subsequent prefetching.

In another embodiment of the invention, the initial execution phase may continue until one or more exit criteria are satisfied. For example, where branch histories are stored, the initial execution phase may continue until one of the branches in an I-line becomes predictable (or strongly predictable) or until an I-cache miss becomes predictable (or strongly predictable). When a given exit branch becomes predictable, a lock bit may be set in the I-line indicating that the initial training phase is complete and that the branch exit address for the strongly predictable exit branch may be used for each subsequent prefetch performed when the I-line is fetched from the L2 cache 112.

In another embodiment of the invention, the branch exit addresses in an I-line may be modified in intermittent training phases. For example, a frequency and duration value for each training phase may be stored. Each time a number of clock cycles corresponding to the frequency has elapsed, a training phase may be initiated and may continue for the specified duration value. In another embodiment, each time a number of clock cycles corresponding to the frequency has elapsed, the training phase may be initiated and continue until specified conditions are satisfied (for example, until a specified level of branch predictability for a branch is reached, as described above).

In one embodiment of the invention, each level of cache and/or memory used in the system 100 may contain a copy of the information contained in an I-line. In another embodiment of the invention, only specified levels of cache and/or memory may contain the information (e.g., branch histories and exit branches) contained in the I-line. In one embodiment, cache coherency principles, known to those skilled in the art, may be used to update copies of the I-line in each level of cache and/or memory.

It is noted that in traditional systems which utilize instruction caches, instructions are typically not modified by the processor 110. Thus, in traditional systems, I-lines are typically discarded after being processed instead of being written back to the I-cache. However, as described herein, in some embodiments, modified I-lines may be written back to the I-cache 222.

As an example, when instructions in an I-line have been processed by the processor core (possible causing the branch exit address and other history information to be updated), the I-line may be written into the I-cache 222 (referred to as a write-back), possibly overwriting an older version of the I-line stored in the I-cache 222. In one embodiment, the I-line may only be placed in the I-cache 222 where changes have been made to information stored in the I-line.

According to one embodiment of the invention, when a modified I-line is written back into the I-cache 222, the I-line may be marked as changed. Where an I-line is written back to the I-cache 222 and marked as changed, the I-line may remain in the I-cache for differing amounts of time. For example, if the I-line is being used frequently by the processor core 114, the I-line may fetched and returned to the I-cache 222 several times, possibly be updated each time. If, however, the I-line is not frequently used (referred to as aging), the I-line may be purged from the I-cache 222. When the I-line is purged from the I-cache 222, the I-line may be written back into the L2 cache 112. In one embodiment, the I-line may only be written back to the L2 cache where the I-line is marked as being modified. In another embodiment, the I-line may always be written back to the L2 cache 112. In one embodiment, the I-line may optionally be written back to several cache levels at once (e.g., to the L2 cache 112 and the I-cache 222) or to a level other than the I-cache 222 (e.g., directly to the L2 cache 112).

### CONCLUSION

As described, addresses of instructions targeted by exit branch instructions contained in a first I-line may be stored and used to prefetch, from an L2 cache, second I-lines containing the targeted instructions. As a result, the number of I-cache misses and corresponding latency of accessing instructions may be reduced, leading to an increase in processor performance.

While the foregoing is directed to embodiments of the present invention, other and further embodiments of the invention may be devised without departing from the basic scope thereof, and the scope thereof is determined by the claims that follow.

What is claimed is:

1. A method of prefetching instruction lines, comprising:
(a) fetching a first instruction line from a level 2 cache;
(b) identifying, in the first instruction line, a branch instruction targeting an instruction that is outside of the first instruction line;
(c) extracting an address from the identified branch instruction; and
(d) prefetching, from the level 2 cache, a second instruction line containing the targeted instruction using the extracted address.

2. The method of claim 1, further comprising:
repeating steps (a) to (d) to prefetch a third instruction line containing an instruction targeted by a branch instruction in the second instruction line.

3. The method of claim 1, further comprising:
repeating steps (a) to (d) until a threshold number of instruction lines are prefetched.

4. The method of claim 1, further comprising,
repeating steps (a) to (d) until a number of prefetched instruction lines containing a threshold number of unpredictable exit branch instructions are prefetched from the level 2 cache.

5. The method of claim 1, further comprising:
identifying, in the first instruction line, a second branch instruction targeting a second instruction that is outside of the first instruction line;
extracting a second address from the identified second branch instruction; and
prefetching, from the level 2 cache, a third instruction line containing the targeted second instruction using the extracted second address.

6. The method of claim 1, wherein the extracted address is stored as an effective address appended to the first instruction line.

7. The method of claim 6, wherein the effective address is calculated during a previous execution of the identified branch instruction.

8. The method of claim 1, wherein the first instruction line contains two or more branch instructions targeting two or more instructions that are outside of the first instruction line, and wherein a branch history value stored in the first instruction line indicates that the identified branch instruction is a predicted branch for the first instruction line.

9. A processor comprising:
a level 2 cache;
a level 1 cache configured to receive instruction lines from the level 2 cache, wherein each instruction line comprises one or more instructions;
a processor core configured to execute instructions retrieved from the level 1 cache; and
circuitry configured to:
(a) fetch a first instruction line from a level 2 cache;
(b) identify, in the first instruction line, a branch instruction targeting an instruction that is outside of the first instruction line;
(c) extract an address from the identified branch instruction; and
(d) prefetch, from the level 2 cache, a second instruction line containing the targeted instruction using the extracted address.

10. The processor of claim 9, wherein the control circuitry is further configured to:
repeat steps (a) to (d) to prefetch a third instruction line containing an instruction targeted by a branch instruction in the second instruction line.

11. The processor of claim 9, wherein the control circuitry is further configured to:
repeat steps (a) to (d) until a threshold number of instruction lines are prefetched.

12. The processor of claim 9, where the control circuitry is further configured to:
repeat steps (a) to (d) until a number of prefetched instruction lines containing a threshold number of unpredictable exit branch instructions are prefetched from the level 2 cache.

13. The processor of claim 9, wherein the control circuitry is further configured to:
identify, in the first instruction line, a second branch instruction targeting a second instruction that is outside of the first instruction line;
extract a second address from the identified second branch instruction; and
prefetch, from the level 2 cache, a third instruction line containing the targeted second instruction using the extracted second address.

14. The processor of claim 9, wherein the extracted address is stored as an effective address appended to the first instruction line

15. The processor of claim 14, wherein the effective address is calculated during a previous execution of the identified branch instruction by the processor core.

16. The processor of claim 9, wherein the first instruction line contains two or more branch instructions targeting two or more instructions that are outside of the first instruction line, and wherein a branch history value stored in the first instruction line indicates that the identified branch instruction is a predicted branch for the first instruction line.

17. A method of storing exit branch addresses in an instruction line, wherein the instruction line comprises one or more instructions, the method comprising:
executing one of the one or more instructions in the instruction line;
determining if the one of one or more of the instructions branches to an instruction in another instruction line; and
if so, appending an exit address to the instruction line corresponding to the other instruction line.

18. The method of claim 17, wherein the instruction line with the appended exit address is written back to a level 2 cache.

19. The method of claim 17, wherein branch history information corresponding to the one of the one or more instructions is stored in the instruction line.

20. The method of claim 19, further comprising:
during a subsequent execution of the one or more instructions in the instruction line, executing a second one of the one or more instructions in the instruction line;
if the second one of the one or more instructions branches to a second instruction in a second instruction line, determining if the branch history information corresponding to one of the one or more instructions indicates that the branch is predictable;
if the branch is not predictable, appending a second exit address to the instruction line corresponding to the second instruction line.

21. The method of claim 17, wherein storing the exit address is performed during an initial execution phase in which a number of instruction lines are executed repeatedly.

22. The method of claim 17, further comprising:
storing the instruction line with the appended exit address in a level two cache;
fetching the instruction line with the appended exit address from the level two cache and placing the instruction line in a level one cache; and
prefetching the other instruction line using the exit address appended to the instruction line.

23. The method of claim 17, wherein the exit address is appended to the instruction line only if executing the exit branch instruction causes a cache miss.

24. The method of claim 17, wherein the exit address is an effective address is calculated during the execution of the one of one or more of the instructions.
